(19) United States
(12) Patent Application Publication
(10) Pub. No.: US 2023/0160920 A1
(43) Pub. Date: May 25, 2023

(54) TIRE POSITION DETERMINATION SYSTEM

(71) Applicant: KABUSHIKI KAISHA TOKAI RIKA DENKI SEISAKUSHO, Aichi (JP)

(72) Inventors: Masanori KOSUGI, Aichi (JP); Yuta TSUCHIKAWA, Aichi (JP); Akito KUMAGAI, Aichi (JP)

(73) Assignee: KABUSHIKI KAISHA TOKAI RIKA DENKI SEISAKUSHO, Aichi (JP)

(21) Appl. No.: 17/986,243

(22) Filed: Nov. 14, 2022

(30) Foreign Application Priority Data
Nov. 19, 2021 (JP) 2021-188357

(51) Int. Cl. G01P 15/18; G01L 17/00; G01S 11/06; B60C 23/04

(52) U.S. Cl. CPC G01P 15/18; G01L 17/005; G01S 11/06; B60C 23/0416; B60C 23/0488

(57) ABSTRACT

A tire position determination system provided in a vehicle including a first tire and a second tire includes an initiator that transmits a command signal, a first detector attached to the first tire, a second detector attached to the second tire, and a monitoring unit. A distance between the first tire and the initiator is equal to or shorter than a distance between the second tire and the initiator. Each of the first detector and the second detector includes an acceleration sensor. A detection signal includes a detection value from the acceleration sensor. The monitoring unit performs determination processing for determining a position of the first tire and a position of the second tire based on positional relation between the detector and the initiator estimated from the detection value from the acceleration sensor.

This nonprovisional application is based on Japanese Patent Application No. 2021-188357 filed with the Japan Patent Office on Nov. 19, 2021, the entire contents of which are hereby incorporated by reference.

### BACKGROUND OF THE INVENTION

### Field of the Invention

The present disclosure relates to a tire position determination system.

### Description of the Background Art

In a tire pressure monitoring system (TPMS) in a vehicle, a detector has conventionally been attached to each of a plurality of tires. The detector attached to each of the plurality of tires transmits pneumatic pressure information to a processing device such as an ECU attached to a vehicle body.

Some TPMS's are provided with an auto location function to automatically determine to which tire among a plurality of tires a detector is attached. For example, Japanese Patent Laying-Open No. 2019-48547 discloses a tire state information detection system that determines to which tire of double tires used in a truck and the like a detector is attached.

Among such TPMS's, there is a system including an initiator. The initiator transmits a command signal to a tire at a prescribed tire position. The detector transmits a response signal to a processing device such as an ECU provided on a vehicle body side based on reception of the command signal from the initiator. The processing device determines attachment of the detector that has transmitted the response signal to a tire at the prescribed tire position.

### SUMMARY OF THE INVENTION

When the initiator is provided at each of a plurality of tire positions, however, cost may increase. On the other hand, when a single initiator is used to transmit a command signal to a plurality of detectors, the processing device provided on the vehicle body side may not be able to determine from which detector it receives the response signal.

The present disclosure was made to solve the problem described above, and an object thereof is to determine a tire position of each of a plurality of tires with the use of a single initiator.

A tire position determination system according to one aspect of the present disclosure is a tire position determination system provided in a vehicle including a first tire and a second tire different from the first tire. The tire position determination system includes an initiator that transmits a command signal, a first detector attached to the first tire, the first detector transmitting a detection signal when the first detector receives the command signal, a second detector attached to the second tire, the second detector transmitting a detection signal when the second detector receives the command signal, and a monitoring unit configured to receive the detection signal. A first distance between the first tire and the initiator is equal to or shorter than a second distance between the second tire and the initiator. Each of the first detector and the second detector includes an acceleration sensor that detects an acceleration in a direction orthogonal to a revolution axis direction. The detection signal includes a detection value from the acceleration sensor. When the monitoring unit receives the detection signal from the first detector or the second detector, the monitoring unit performs determination processing for determining whether a detector that has transmitted the detection signal is the first detector or the second detector based on positional relation between the detector that has transmitted the detection signal and the initiator estimated from the detection value from the acceleration sensor included in the received detection signal.

According to the aspect above, with the use of a value of the acceleration detected by each detector in addition to signal intensity of the detection signal received from each detector, a larger number of statuses of revolution of each tire can be specified. As variations of the statuses of revolution are wider, a larger number of tire positions can be specified. The tire position determination system thus determines a tire position of each of a plurality of tires with the use of a single initiator.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically showing a configuration of a vehicle to which a tire position determination system according to a first embodiment is applied.

FIG. 2 is a side view of the vehicle.

FIG. 3 is a block diagram showing an exemplary configuration of a tire detector.

FIG. 4 is a diagram showing an exemplary appearance of the tire detector.

FIG. 5 is a transition diagram of arrangement of the tire detector when a tire revolves.

FIG. 6 shows a graph of exemplary attenuation when radio wave intensity T1 is set as transmission intensity.

FIG. 7 is a diagram illustrating the graph shown in FIG. 6 by referring to an initiator and an appearance of the tire.

FIG. 8 is a flowchart showing exemplary tire position determination processing in the first embodiment.

FIG. 9 is a diagram for illustrating arrangement of the initiator in a modification of the first embodiment.

FIG. 10 shows a graph showing exemplary attenuation when radio wave intensity T2 is set as transmission intensity.

FIG. 11 is a diagram illustrating the graph shown in FIG. 10 by referring to the initiator and an appearance of the tire.

FIG. 12 is a flowchart showing exemplary tire position determination processing in a second embodiment.

FIG. 13 is a diagram for illustrating arrangement of the initiator in a modification of the second embodiment.

### DESCRIPTION OF THE PREFERRED EMBODIMENTS

An embodiment of the present disclosure will be described in detail below with reference to the drawings. The same or corresponding elements in the drawings have the same reference characters allotted and description thereof will not be repeated.

### First Embodiment

<Overall Configuration>

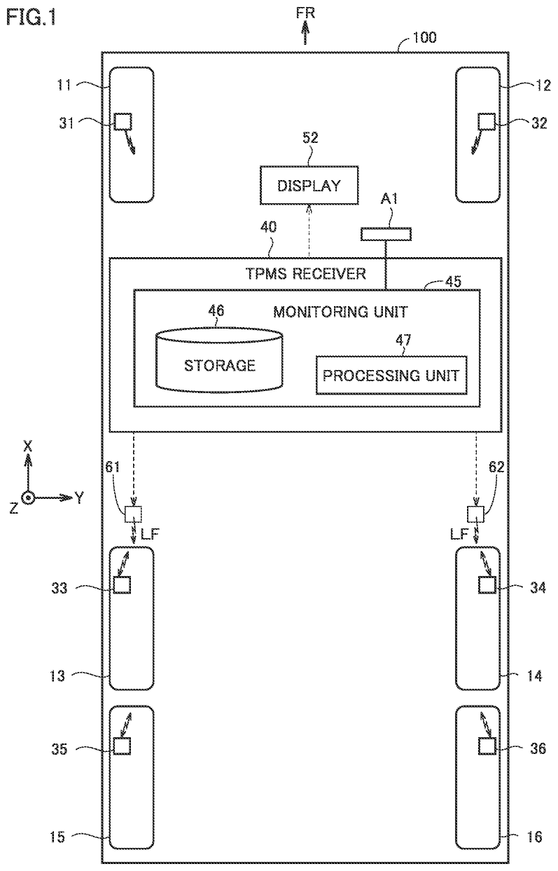

FIG. 1 is a diagram schematically showing a configuration of a vehicle 100 to which a tire position determination system according to a first embodiment is applied.

Vehicle 100 according to the first embodiment is a vehicle including tires 11 and 12 on a front side which are steering wheels and tires 13 to 16 on a rear side which are non-steering wheels. Tires 11 to 16 are each in such a form that a single tire is attached at a single tire attachment position. A direction FR shown in FIG. 1 represents a direction of forward travel of vehicle 100. Tires 13 to 16 may each be such double (twin or dual) tires that two tires are attached at a single tire attachment position.

In the description below, a vertical direction when vehicle 100 is arranged on the plane is defined as a “Z-axis direction,” a direction perpendicular to the Z-axis direction, in the direction of forward travel of vehicle 100, is defined as a “positive direction along an X axis,” and a direction perpendicular to an X-axis direction is defined as a “Y-axis direction.” Hereafter, a positive direction along a Z axis in each figure may be referred to as an upper side and a negative direction along the Z axis may be referred to as a lower side, the positive direction along the X axis may be referred to as a front side and a negative direction along the X axis may be referred to as a rear side, and a positive direction along a Y axis may be referred to as a right side and a negative direction along the Y axis may be referred to as a left side.

Vehicle 100 includes a system that monitors a pneumatic pressure of each tire (TPMS). Specifically, vehicle 100 includes a plurality of tire detectors 31 to 36 each detecting a tire pressure, initiators 61 and 62, and a TPMS receiver 40. Tire detectors 31 to 36 are attached to wheels of tires 11 to 16, respectively. Tire detectors 31 to 36 may each be formed integrally with a valve for intake of air into each tire. Tire detectors 31 to 36 may each be formed separately from the valve.

Each of tire detectors 31 to 36 is activated when a prescribed activation condition is satisfied, and detects a pneumatic pressure of each tire and transmits a radio signal in an ultra high frequency (UHF) band (which is also simply referred to as a “UHF signal” below) that includes a result of detection. The “prescribed activation condition” is set in advance to be satisfied regularly or irregularly. Tire detectors 31 to 36 are thus intermittently activated at timings different from one another and transmit UHF signals.

The UHF signals outputted from tire detectors 31 to 36 include information indicating specific ID numbers for identifying at least respective tire detectors 31 to 36. Specifically, the UHF signals outputted from tire detectors 31 to 36 include ID numbers “01” to “06”, respectively.

The UHF signals outputted from tire detectors 31 to 36 each include information representing a tire pressure in addition to the information indicating the ID number. As TPMS receiver 40 receives the UHF signal outputted from each of tire detectors 31 to 36, it can monitor a pneumatic pressure of each tire.

Tires identical in specifications and construction are employed as tires 11 to 16 for allowing tire rotation. Therefore, tire detectors identical in configuration are adopted also for tire detectors 31 to 36. When tires 11 to 16 do not have to be described as being distinguished from one another, tires 11 to 16 are simply referred to as a “tire 10” below. When tire detectors 31 to 36 do not have to be described as being distinguished from one another, tire detectors 31 to 36 are simply referred to as a “tire detector 30.” Tires 11 to 16 are identical in tire diameter.

TPMS receiver 40 is provided on a vehicle body side of vehicle 100. TPMS receiver 40 includes a monitoring unit 45 that monitors a pneumatic pressure of each tire. Monitoring unit 45 includes a storage 46, a processing unit 47, and an antenna A1. Antenna A1 is configured to receive a UHF signal transmitted from tire detector 30. Monitoring unit 45 accepts the UHF signal received by antenna A1.

Processing unit 47 includes a processor such as a not-shown central processing unit (CPU), a memory, and an input and output buffer. The memory includes a read only memory (ROM) and a random access memory (RAM). The processor develops a program stored in the ROM on the RAM and executes the same. Various types of processing performed by processing unit 47 are described in the program stored in the ROM.

Information indicating a position of a tire where each tire detector 30 is attached and information indicating a tire pressure are stored in storage 46 as being brought in correspondence with an ID number of each tire detector 30. In the first embodiment, six tire positions (a front left side, a front right side, a rear first-row left side, a rear first-row right side, a rear second-row left side, and a rear second-row right side) in total are stored in correspondence with the respective ID numbers of tire detectors 30.

Specifically, the tire position “front left side” is brought in correspondence with the ID number “01” and the tire position “front right side” is brought in correspondence with the ID number “02”. The tire position “rear first-row left side” is brought in correspondence with the ID number “03” and the tire position “rear first-row right side” is brought in correspondence with the ID number “04”. The tire position “rear second-row left side” is brought in correspondence with the ID number “05” and the tire position “rear second-row right side” is brought in correspondence with the ID number “06”. When tires are rotated and monitoring unit 45 detects attachment at different tire positions, monitoring unit 45 updates relation between the ID number and the tire position.

When monitoring unit 45 receives a UHF signal, it checks the ID number included in the UHF signal against the ID number stored in storage 46, and obtains the tire position brought in correspondence with the ID number. Monitoring unit 45 updates the pneumatic pressure at the obtained tire position with the tire pressure included in the UHF signal.

For example, when monitoring unit 45 receives the UHF signal including the ID number “01”, it refers to correspondence between the ID number “01” and the tire position stored in storage 46. In storage 46, the “front left side” is brought in correspondence with the ID number “01” as the tire position. Monitoring unit 45 updates the pneumatic pressure on the “front left side” with the tire pressure included in the UHF signal.

TPMS receiver 40 can have information on correspondence between the tire position and the tire pressure stored in storage 46 shown on a display 52. Display 52 is arranged at a position where a driver can visually recognize the same. Display 52 is arranged, for example, in an instrument panel within the vehicle.

Monitoring unit 45 determines whether or not the tire pressure included in the received UHF signal is equal to or lower than a low-pressure threshold value. When the tire pressure is equal to or lower than the low-pressure threshold value, monitoring unit 45 has the tire position where the tire pressure has become the low-pressure threshold value shown on display 52 together with a warning. TPMS receiver 40 determines the tire pressure each time it receives the UHF signal and monitors each pneumatic pressure of the tire. The driver can thus recognize in real time the position of the tire the tire pressure of which has become equal to or lower than the low-pressure threshold value.

Initiators 61 and 62 for activating tire detectors 33 to 36 on the rear side are electrically connected to TPMS receiver 40. Initiator 61 is arranged in the vicinity of tire 13 on the left side in the rear first row and used for activation of tire detectors 33 and 35. Initiator 62 is arranged in the vicinity of tire 14 on the right side in the rear first row and used for activation of tire detectors 34 and 36.

Initiators 61 and 62 identical in configuration are adopted. When initiators 61 and 62 do not have to be described as being distinguished from each other, they are also denoted as an “initiator 60” below without being distinguished from each other.

Initiator 60 includes a not-shown antenna, and is configured to output a radio signal in a low frequency (LF) band (which is also simply referred to as an “LF signal” below) from the antenna. Initiator 60 transmits the LF signal to tire detector 30 based on an instruction from monitoring unit 45. The LF signal is a command signal for instructing tire detector 30 to perform a specific operation.

Each tire detector 30 can receive the LF signal from initiator 60. Each tire detector 30 is configured to output a UHF signal when the prescribed activation condition described above is satisfied. The “prescribed activation condition” in the first embodiment includes reception of the LF signal. In other words, each tire detector 30 transmits the UHF signal on condition that it receives the LF signal.

Relation between each tire position and the position of initiator 61 or 62 is stored in storage 46. For example, a tire position closest to initiator 61 being “rear first-row left” and a tire position second closest thereto being “rear second-row left” are stored in storage 46.

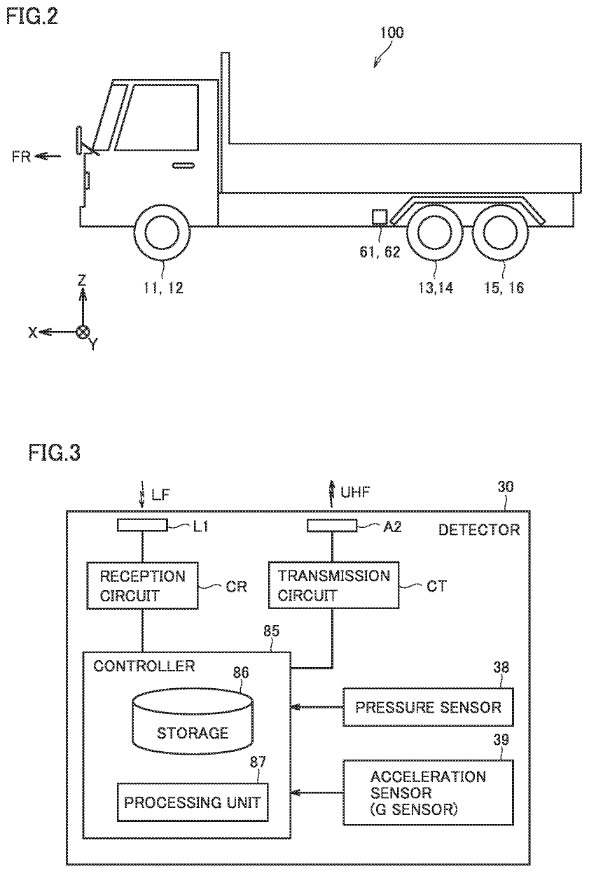

FIG. 2 is a side view of vehicle 100. FIG. 2 shows vehicle 100 when viewed from a side of the negative direction of the Y axis. Initiators 61 and 62 are arranged on a side of the positive direction along the X axis of tires 13 and 14 on the rear side. In other words, tire 13 is arranged between initiator 61 and tire 15. Tire 14 is arranged between initiator 62 and tire 16.

<Configuration of Tire Detector 30>

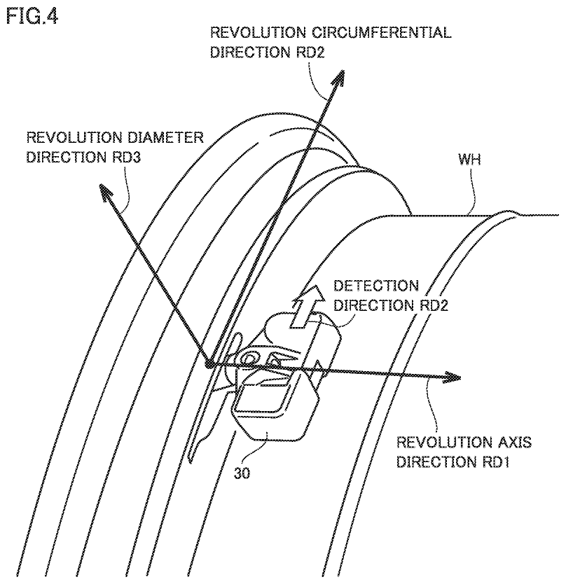

An exemplary configuration of tire detector 30 will be described below with reference to FIGS. 3 and 4. FIG. 3 is a block diagram showing an exemplary configuration of tire detector 30. As shown in FIG. 3, tire detector 30 includes a controller 85, a pressure sensor 38, an acceleration sensor (G sensor) 39, antennas L1 and A2, a reception circuit CR, and a transmission circuit CT.

Controller 85 includes a storage 86 and a processing unit 87. Processing unit 87 includes a processor such as a not-shown CPU, a memory, and an input and output buffer. The memory includes a ROM and a RAM. The processor develops a program stored in the ROM on the RAM and executes the same. Various types of processing performed by processing unit 87 are described in the program stored in the ROM.

In storage 86, an ID number specific for each tire detector 30 shown in FIG. 1 is stored. In storages 86 of tire detectors 31 to 36, “01” to“06” are stored as the ID numbers, respectively.

Antenna L1 receives the LF signal transmitted from initiator 61 or 62. Controller 85 accepts the LF signal received by antenna L1 through reception circuit CR. Reception circuit CR detects reception intensity of the LF signal received by antenna L1.

Reception circuit CR outputs a voltage in accordance with radio wave intensity (received signal strength indicator (RSSI) signal) of the inputted LF signal. Controller 85 obtains intensity (which is referred to as an “RSSI value” below) of the received signal (radio wave) resulting from A/D conversion of this voltage. The RSSI value in the first embodiment is obtained as a voltage ratio [dBμV] to 1 μV. The unit of the RSSI value may be a voltage [V] or power [W]. Reception circuit CR is configured not to receive the LF signal lower than radio wave intensity M but to receive the LF signal equal to or higher than radio wave intensity M.

Controller 85 controls transmission circuit CT to transmit a UHF signal from antenna A2. Controller 85 outputs the UHF signal at timing when a prescribed activation condition is satisfied. Tire detector 30 is provided with a not-shown battery, and operates with electric power supplied from the battery. This battery is constructed not to readily externally be charged. Therefore, in tire detector 30 in the first embodiment, desirably, operating time is minimized to suppress power consumption by tire detector 30.

From this point of view, the “prescribed activation condition” is set in advance to suppress a frequency of activation of tire detector 30 as much as possible. For example, the prescribed activation condition may include such a timer-based activation condition that a timer has counted lapse of prescribed timer time since previous stop and such an acceleration-based activation condition that a result of detection (which is also referred to as an “acceleration G” below) by acceleration sensor 39 has attained to a specific value (for example, a maximum value or a minimum value).

The “timer time” used as the timer-based activation condition described above may be set to a fixed value or a variable value that varies with acceleration G. For example, controller 85 may determine whether or not a tire is revolving based on acceleration G which represents the result of detection by acceleration sensor 39 and change the set timer time.

In tire detector 30 in the first embodiment, the prescribed activation condition includes reception of the LF signal from initiator 60. Tire detector 30 transmits a UHF signal including detection information representing an ID number, a tire pressure P, acceleration G, and an RSSI value to monitoring unit 45 by being triggered by reception of the LF signal.

Pressure sensor 38 detects a tire pressure and outputs a result of detection (which is also referred to as “tire pressure P” below) to controller 85. Acceleration sensor 39 detects an acceleration in a uniaxial direction generated in a direction orthogonal to a revolution axis direction of tire 10 and outputs a result of detection to controller 85. Acceleration sensor 39 in the first embodiment has a revolution circumferential direction of tire 10 as a detection direction. Tire detector 30 may further include a temperature sensor that detects a tire temperature in addition to pressure sensor 38 and acceleration sensor 39.

FIG. 4 is a diagram showing an exemplary appearance of tire detector 30. Tire detector 30 is attached as being fixed to a wheel WH of tire 10. A position of tire detector 30 changes with revolution of tire 10. FIG. 4 shows a revolution axis direction RD1, a revolution circumferential direction RD2, and a revolution diameter direction RD3 of wheel WH when tire 10 revolves. As described above, acceleration sensor 39 of tire detector 30 in the first embodiment is the uniaxial acceleration sensor having revolution circumferential direction RD2 as the detection direction.

<Detection Value from Acceleration Sensor 39>

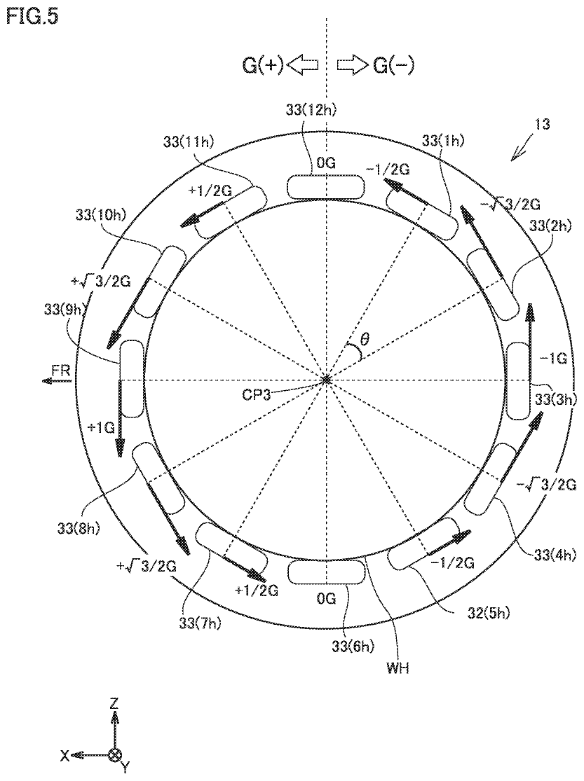

FIG. 5 is a transition diagram of arrangement of tire detector 33 when tire 13 revolves. FIG. 5 shows transition of arrangement of tire detector 33 when tire 13 is viewed from the negative side (outer side of vehicle 100) in the Y-axis direction. FIG. 5 shows the detection value from acceleration sensor 39 while vehicle 100 remains stopped.

FIG. 5 shows arrangements 1h to 12h as twelve patterns of exemplary arrangement of tire detector 33. Arrangement 12h of tire detector 33 is such an arrangement that tire detector 33 is located in revolution diameter direction D3 extending from a central point CP3 of tire 13 in the positive direction along the Z-axis. Arrangement 12h is referred to as arrangement at “0 degree” or “+360 degrees” below.

Arrangement 1h represents arrangement of tire detector 33 when tire 13 revolves by 0 degrees clockwise from the state of arrangement 12h. 0 degrees in FIG. 5 is set to thirty degrees. Arrangement 1h is referred to as arrangement at “+30 degrees” below. Arrangement 2h represents arrangement of tire detector 33 when tire 13 revolves by 0 degrees clockwise from the state of arrangement 1h. Arrangement 2h is referred to as arrangement at “+60 degrees” below.

Arrangement 3h represents arrangement of tire detector 33 when tire 13 revolves by 0 degrees clockwise from the state of arrangement 2h. Arrangement 3h is referred to as arrangement at “+90 degrees” below. FIG. 5 thus illustrates twelve patterns of exemplary arrangement of tire detector 33 at 0 degree (360 degrees), +30 degrees, +60 degrees, +90 degrees, +120 degrees, +150 degrees, +180 degrees, +210 degrees, +240 degrees, +270 degrees, +300 degrees, and +330 degrees.

As described with reference to FIG. 4, acceleration sensor 39 of tire detector 33 is a uniaxial acceleration sensor that detects an acceleration only in one direction and has a tire circumferential direction (revolution circumferential direction RD2) as the detection direction. Therefore, as shown in FIG. 5, an acceleration of gravity in the detection direction is highest at arrangement 3h (+90 degrees) or arrangement 9h (+270 degrees) of tire detector 33.

In the example in FIG. 5, tire 33 is attached such that the detection value from acceleration sensor 39 at arrangement 9h is +1 G. In other words, the detection value from acceleration sensor 39 when tire detector 33 is at arrangement 3h is −1 G.

When tire detector 33 is at arrangement 8h or arrangement 10h the detection value from acceleration sensor 39 is +√ 3/2 G. When tire detector 33 is at arrangement 7h or arrangement 11h, the detection value from acceleration sensor 39 is +½ G. When tire detector 33 is at arrangement 12h or arrangement 6h, the detection value from acceleration sensor 39 is 0 G.

When tire detector 33 is at arrangement 1h or arrangement 5h, the detection value from acceleration sensor 39 is −½ G. When tire detector 33 is at arrangement 2h or arrangement 4h, the detection value from acceleration sensor 39 is −√ 3/2 G. Depending on a direction of attachment of tire detector 33, positive and negative signs of the acceleration of gravity as the detection value shown in FIG. 5 may be reversed.

Tire detector 33 transmits the UHF signal including the detection value from acceleration sensor 39 to monitoring unit 45. Monitoring unit 45 can estimate arrangement of tire detector 33 based on the detection value from acceleration sensor 39. As shown in FIG. 5, the detection values from acceleration sensor 39 are in line symmetry with respect to the Y axis that passes through central point CP3.

Estimation of arrangement of tire detector 33 based on the detection value from acceleration sensor 39 in the first embodiment will more specifically be described. As described with reference to FIGS. 1 and 2, initiator 61 is arranged on the side of the positive direction along the X axis of tire 13. With a straight line in revolution diameter direction RD3 extending from central point CP3 of tire 13 shown in FIG. 5 toward the positive direction along the Z-axis being defined as a boundary, a region of tire 13 can be divided into a region on a side close to initiator 61 and a region on a side distant from initiator 61. In the example in FIG. 5, arrangement 7h to arrangement 11h are arrangements in the region on the side close to initiator 61. Arrangement 1h to arrangement 5h are arrangements in the region on the side distant from initiator 61.

Initiator 61 is arranged on the side of the positive direction in the X-axis direction of tire 13. When arrangement of tire detector 33 is on the side close to initiator 61, the detection values from acceleration sensor 39 are all positive. When arrangement of tire detector 33 is on the side distant from initiator 61, the detection values from acceleration sensor 39 are all negative. By determining whether the detection value from acceleration sensor 39 included in the received UHF signal is positive or negative, monitoring unit 45 can determine whether tire detector 33 is arranged on the side close to or distant from initiator 61.

Monitoring unit 45 can obtain at least two arrangements as arrangement candidates for tire detector 33 based on the detection value from acceleration sensor 39. For example, when monitoring unit 45 finds the detection value from acceleration sensor 39 as +√ 3/2 G, tire detector 33 obtains arrangement 8h and arrangement 10h as arrangement candidates. Alternatively, when monitoring unit 45 finds the detection value from acceleration sensor 39 as −½ G, tire detector 33 obtains arrangement 1h and arrangement 5h as arrangement candidates.

When the detection value from acceleration sensor 39 is +1 G, monitoring unit 45 estimates that tire detector 33 is in arrangement 9h. When the detection value from acceleration sensor 39 is −1 G, monitoring unit 45 estimates that tire detector 33 is in arrangement 3h. For tire detector 35 attached to tire 15 as well, relation between arrangement of tire detector 35 and the detection value from acceleration sensor 39 is similar to relation between the arrangement of tire detector 33 and the detection value from acceleration sensor 39 described with reference to FIG. 5.

Acceleration sensor 39 of tire detector 30 in the first embodiment may detect the acceleration generated in revolution diameter direction RD3 (centrifugal direction). When the acceleration generated in revolution diameter direction RD3 is detected, detection values from acceleration sensor 39 are in line symmetry with respect to the Z-axis that passes through central point CP3. Therefore, monitoring unit 45 is unable to determine whether or not tire detector 30 is arranged in the region close to the initiator only based on the positive and negative signs of the detection value from acceleration sensor 39.

When acceleration sensor 39 detects the acceleration generated in revolution diameter direction RD3, monitoring unit 45 detects the acceleration consecutively two times at intervals at least shorter than a period of revolution of tire 10 by ninety degrees. Since monitoring unit 45 can thus uniquely determine arrangement of tire detector 30 based on the detection value from acceleration sensor 39, it can determine whether or not tire detector 30 is arranged in the region close to the initiator.

<As to Attenuation of Radio Wave Intensity>

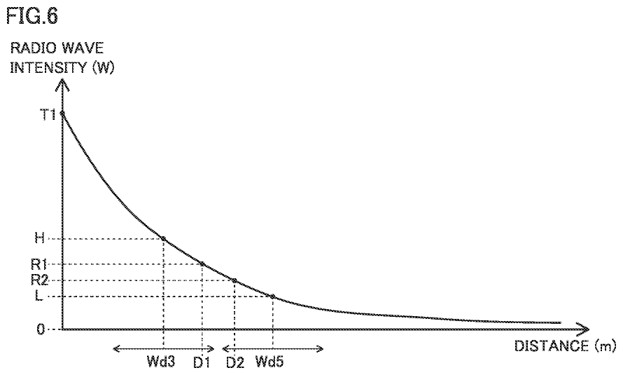

FIG. 6 shows a graph of exemplary attenuation when radio wave intensity T1 is set as transmission intensity. The abscissa in FIG. 6 represents a distance (unit: m) of radiation of the LF signal from initiator 61 and the ordinate represents radio wave intensity (unit: W) of the LF signal. As the distance is longer, an amount of attenuation is larger and radio wave intensity of the LF signal gradually becomes lower. As the distance of radiation of the LF signal emitted from initiator 61 is longer, the amount of attenuation of radio wave intensity of the LF signal is larger. FIG. 6 shows radio wave intensities L and H. Radio wave intensity H is higher than radio wave intensity L.

Radio wave intensity H may correspond to the “first threshold value” in the present disclosure. Radio wave intensity L may correspond to the “second threshold value” in the present disclosure.

FIG. 6 shows an example in which initiator 61 transmits the LF signal with radio wave intensity T1 being set as transmission intensity. Radio wave intensity at the time of transmission from initiator 61 is referred to as “transmission intensity” below. On the other hand, radio wave intensity at the time when tire detector 30 receives the LF signal with radio wave intensity thereof being attenuated is referred to as “reception intensity.” Radio wave intensity T1 represents radio wave intensity at which both of tire detectors 33 and 35 can sufficiently receive the LF signal even though the LF signal attenuates.

A width Wd3 represents a width of a range of possible distances between tire detector 33 and initiator 61. A width Wd5 represents a width of a range of possible distances between tire detector 35 and initiator 61. Arrangement of tire detectors 33 and 35 changes with revolution of tires 13 and 15. Therefore, distances between tire detectors 33 and 35 and initiator 61 change within the ranges of width Wd3 and Wd5. Width Wd3 and Wd5 can be estimated from arrangement of initiator 61 and tires 13 and 15 and the tire diameter of tires 13 and 15.

As shown in FIG. 6, radio wave intensity H corresponds to a distance at the center of width Wd3. Radio wave intensity L corresponds to a distance at the center of width Wd5. Radio wave intensities H and L are stored in storage 46 of monitoring unit 45.

Monitoring unit 45 in the first embodiment determines the tire position of tire 10 to which tire detector 30 is attached based on the RSSI value. More specifically, when monitoring unit 45 receives the UHF signal including the RSSI value equal to or higher than radio wave intensity H, it determines that the UHF signal has been transmitted from tire detector 33 attached to tire 13 close to initiator 61. When monitoring unit 45 receives the UHF signal including the RSSI value lower than radio wave intensity L, it determines that the UHF signal has been transmitted from tire detector 35 attached to tire 15 distant from initiator 61.

When monitoring unit 45 receives the UHF signal including the RSSI value equal to or higher than radio wave intensity L and lower than radio wave intensity H, it may not be able to determine the tire position of tire detector 30 that has transmitted the UHF signal. An example in which the monitoring unit is unable to determine the tire position will be described by referring to a distance D1 and a distance D2.

Distance D1 is a distance which is included within width Wd3 and relatively close to width Wd5. Distance D2 is a distance which is included within width Wd5 and relatively close to width Wd3. According to the graph shown in FIG. 6, reception intensity at distance D1 is radio wave intensity R1 and reception intensity at distance D2 is radio wave intensity R2.

Though radio wave intensity of the LF signal attenuates with the graph shown in FIG. 6 being defined as the reference, an error may be caused by various factors. Specifically, the amount of attenuation of radio wave intensity of the LF signal is affected by an ambient environment and radio wave intensity may change by an error from the graph in FIG. 6. Reception intensity at distance D1 may thus attain to radio wave intensity R2 and reception intensity at distance D2 may attain to radio wave intensity R1.

When the RSSI value included in the UHF signal is equal to or higher than radio wave intensity L and lower than radio wave intensity H, in consideration of the error, monitoring unit 45 is unable to determine the tire position only based on the RSSI value. When monitoring unit 45 in the first embodiment receives the UHF signal including radio wave intensity equal to or higher than radio wave intensity L and lower than radio wave intensity H, it determines the tire position with a tire position determination method which will be described later.

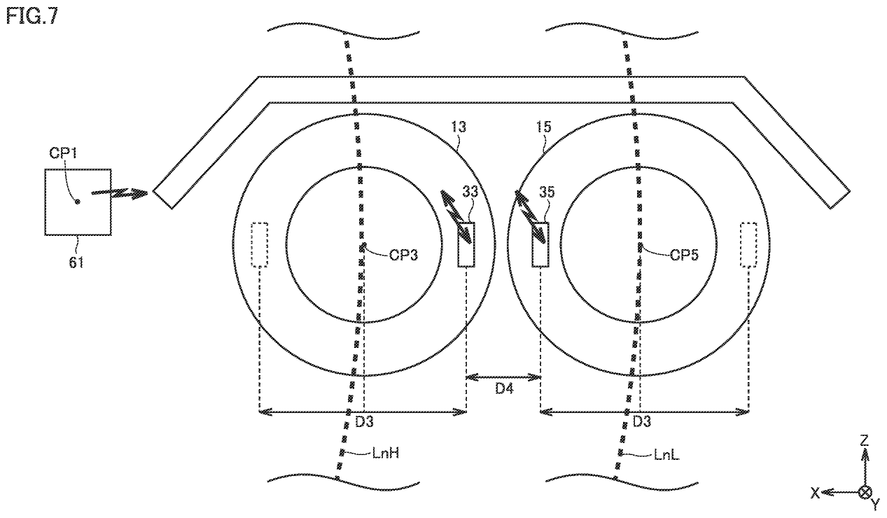

FIG. 7 is a diagram illustrating the graph shown in FIG. 6 by referring to initiator 61 and an appearance of tires 13 and 15. FIG. 7 shows initiator 61 and tires 13 and 15 when viewed from the side of the negative direction along the Y axis as in FIG. 2.

A distance D3 represents a distance between tire detector 33 at arrangement 3h and tire detector 33 at arrangement 9h. Since tire 13 and tire 15 are identical in tire diameter, distance D3 is defined also as a distance between tire detector 35 at arrangement 3h and tire detector 35 at arrangement 9h. A distance D4 represents a distance between tire detector 33 at arrangement 3h and tire detector 35 at arrangement 9h.

Though distances D3 and D4 in FIG. 7 represent only the distance along the X-axis direction for the sake of convenience of illustration, distances D3 and D4 are each a distance in three dimensions. Since distance D4 at the time when tire detector 33 and tire detector 35 are closest to each other is thus short, probability of reception of the LF signal by both of tire detector 33 and tire detector 35 as a result of an error in the amount of attenuation of the LF signal becomes high. In other words, monitoring unit 45 may not be able to determine the tire position only based on the RSSI value. In the first embodiment, distance D4 is shorter than half distance D2.

A line LnL is a line that shows in a simplified manner, a boundary at which reception intensity attains to radio wave intensity L when it is assumed that the amount of attenuation follows the graph shown in FIG. 6 without consideration of the error. A line LnH is a line that similarly shows in a simplified manner, a boundary at which reception intensity attains to radio wave intensity H when it is assumed that the amount of attenuation follows the graph shown in FIG. 6 without consideration of the error.

A distance between a central point CP1 of initiator 61 and central point CP3 of tire 13 may correspond to the “first distance” in the present disclosure. A distance between central point CP1 of initiator 61 and a central point CP5 of tire 15 may correspond to the “second distance” in the present disclosure.

### Tire Position Determination in First Embodiment

When the tire position determination system in the first embodiment receives the UHF signal including radio wave intensity equal to or higher than radio wave intensity L and lower than radio wave intensity H, it determines the tire position based on arrangement of tire detector 30 estimated from the detection value from acceleration sensor 39.

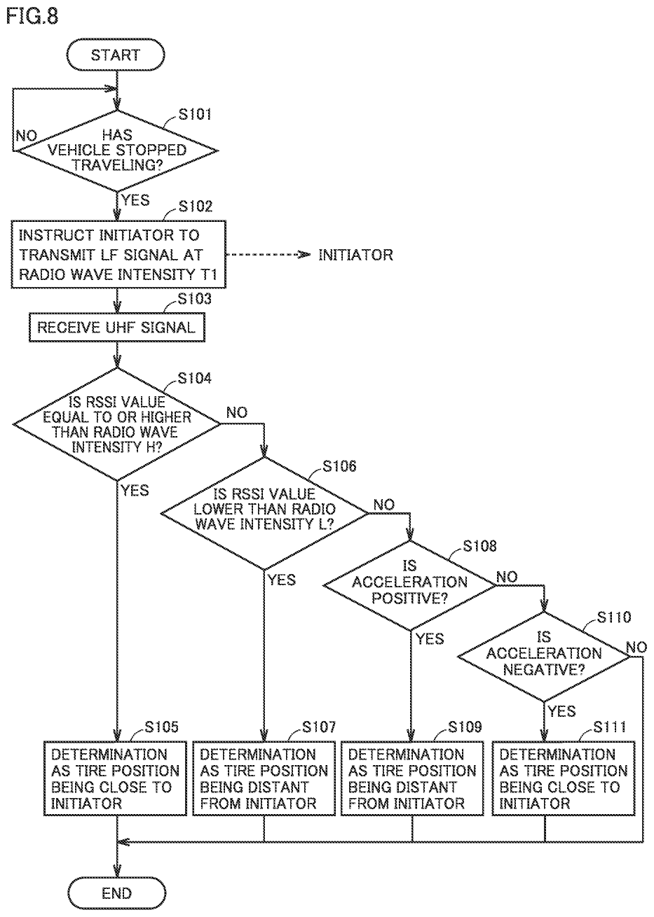

FIG. 8 is a flowchart showing exemplary tire position determination processing in the first embodiment. Monitoring unit 45 determines whether or not vehicle 100 has stopped traveling (step S101). Monitoring unit 45 determines whether or not vehicle 100 has stopped with the use of a not-shown vehicle velocity sensor. When vehicle 100 has not stopped traveling (NO in step S101), monitoring unit 45 repeats processing in step S101.

When vehicle 100 has stopped traveling (YES in step S101), initiator 61 is instructed to transmit the LF signal at radio wave intensity T1 (step S102). Initiator 61 receives the transmission instruction and transmits the LF signal at radio wave intensity T1. Each of tire detectors 33 and 35 transmits the UHF signal in response to reception of the LF signal.

Monitoring unit 45 receives the UHF signal (step S103). Monitoring unit 45 determines whether or not the RSSI value included in the received UHF signal is equal to or higher than radio wave intensity H (step S104). When the RSSI value is equal to or higher than radio wave intensity H (YES in step S104), monitoring unit 45 determines that the UHF signal has been transmitted from tire detector 33 of tire 13 attached at the tire position close to initiator 61 (step S105). In other words, monitoring unit 45 determines that the tire position of tire detector 30 that has transmitted the UHF signal received in step S103 is “rear first-row left.”

When the RSSI value is lower than radio wave intensity H (NO in step S104), monitoring unit 45 determines whether or not the RSSI value included in the received UHF signal is lower than radio wave intensity L (step S106). When the RSSI value is lower than radio wave intensity L (YES in step S106), monitoring unit 45 determines that the UT-IF signal has been transmitted from tire detector 35 of tire 15 attached at the tire position distant from initiator 61 (step S107). In other words, monitoring unit 45 determines that the tire position of tire detector 30 that has transmitted the UHF signal received in step S103 is “rear second-row left.”

When the RSSI value is not lower than radio wave intensity L (NO in step S106), monitoring unit 45 determines whether or not the detection value from acceleration sensor 39 included in the UHF signal received in step S103 is positive (step S108). In other words, monitoring unit 45 determines whether or not tire detector 30 is arranged in the region in tire 10 close to the initiator based on the detection value from acceleration sensor 39. Monitoring unit 45 can thus estimate positional relation between tire detector 30 and initiator 61 based on the detection value from acceleration sensor 39.

When the detection value from acceleration sensor 39 is positive (YES in step S108), monitoring unit 45 determines that the UHF signal in step S103 has been transmitted from tire detector 35 of tire 15 at the tire position distant from initiator 61 (step S109).

As shown in FIG. 7, between line LnL and line LnH, tire detector 35 of tire 15 is arranged in the region close to initiator 61 in tire 15. On the other hand, between line LnL and line LnH, tire detector 33 of tire 13 is arranged in the region distant from initiator 61 in tire 13. Therefore, monitoring unit 45 can determine that the tire position of tire detector 30 that has transmitted the UHF signal received in step S103 is “rear second-row left.”

When the detection value from acceleration sensor 39 is not positive (NO in step S108), monitoring unit 45 determines whether or not the detection value from acceleration sensor 39 included in the UHF signal received in step S103 is negative (step S110). In other words, monitoring unit 45 determines whether or not tire detector 30 is arranged in the region distant from the initiator in tire 10 based on the detection value from acceleration sensor 39. Monitoring unit 45 can thus estimate positional relation between tire detector 30 and initiator 61 based on the detection value from acceleration sensor 39.

When the detection value from acceleration sensor 39 is negative (YES in step S110), monitoring unit 45 determines that the UHF signal in step S103 has been transmitted from tire detector 33 in tire 13 at the tire position close to initiator 61 (step S111). Monitoring unit 45 can determine that the tire position of tire detector 30 that has transmitted the UHF signal received in step S103 is “rear first-row left.”

When the detection value from acceleration sensor 39 is not negative (NO in step S110), monitoring unit 45 quits the process without determining the tire position. This is because, even based on the detection value from acceleration sensor 39, monitoring unit 45 is unable to determine the tire position when tire detector 30 is in arrangement 12h or arrangement 6h.

Thus, in the first embodiment, even when monitoring unit 45 receives the UHF signal including the RSSI value lower than radio wave intensity H and equal to or higher than radio wave intensity L, it can determine the tire position based on arrangement of tire detector 30 estimated from the detection value from acceleration sensor 39. The tire position determination system in the first embodiment can thus determine the tire position of each of tire 13 and tire 15 with the use of single initiator 61, without providing the initiator for each of tire 13 and tire 15.

FIG. 8 illustrates a configuration in which monitoring unit 45 has initiator 61 transmit the LF signal when vehicle 100 stops. In one aspect, monitoring unit 45 may have initiator 61 transmit the LF signal also while vehicle 100 is traveling. In this case, monitoring unit 45 obtains only the acceleration of gravity by removing centrifugal force generated by travel of vehicle 100 from the detection value from acceleration sensor 39. Monitoring unit 45 calculates centrifugal force generated by travel of vehicle 100 in accordance with the velocity of vehicle 100 received from a not-shown speedometer.

### Modification of First Embodiment

In the first embodiment, tire 13 is arranged between initiator 61 and tire 15. Initiator 61, however, is not necessarily arranged at the position shown in FIG. 7 and may be arranged at various positions.

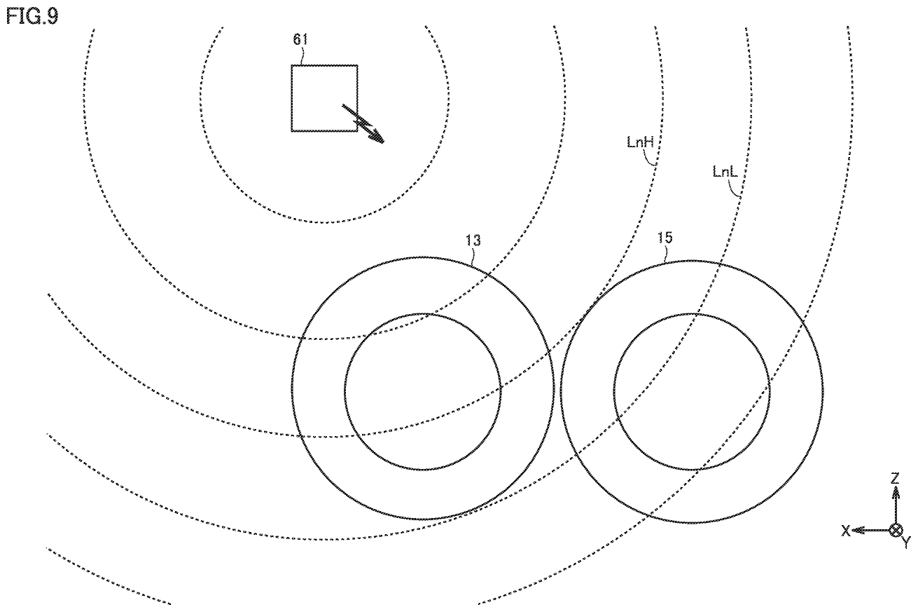

FIG. 9 is a diagram for illustrating arrangement of initiator 61 in a modification of the first embodiment. As shown in FIG. 9, initiator 61 is arranged on the side of the positive direction along the Z-axis of tire 13. Concentric circles shown with dashed lines around the transmission circuit of initiator 61 represent radio wave intensities of the LF signal.

The tire position determination system in the modification of the first embodiment determines radio wave intensities L and H defined as the threshold values in accordance with arrangement of initiator 61 and tires 13 and 15. As shown in FIG. 9, in the tire position determination system in the modification of the first embodiment, line LnH represents a boundary line in contact with tire 15. In other words, radio wave intensity H is set such that tire 15 is not included but at least a part of tire 13 is included in a range equal to or higher than radio wave intensity H.

In the tire position determination system in the modification of the first embodiment, line LnL represents a boundary line in contact with tire 13. In other words, radio wave intensity L is set such that tire 13 is not included but at least a part of tire 15 is included in a range lower than radio wave intensity L.

In the modification of the first embodiment, the region close to initiator 61 in tire 13 is a region where radio wave intensity is equal to or higher than radio wave intensity H and the region distant from initiator 61 in tire 13 is a region where radio wave intensity is lower than radio wave intensity H. The region close to initiator 61 in tire 15 is a region where radio wave intensity is equal to or higher than radio wave intensity L and the region distant from initiator 61 in tire 15 is a region where radio wave intensity is lower than radio wave intensity L.

Thus, even in an example in which initiator 61 is arranged as in FIG. 9, monitoring unit 45 can determine the tire position based on whether tire detector 33 or 35 is arranged in the region close to or distant from initiator 61 when the RSSI value is lower than radio wave intensity H and equal to or higher than radio wave intensity L. The tire position determination system in the first embodiment is thus applicable without limitation being imposed by arrangement of initiator 61.

In the modification of the first embodiment, in the tire position determination system, initiator 61 may be arranged equidistantly from the tire center of tire 13 and the tire center of tire 15. In this case, in the tire position determination system, when a combination of the RSSI value in the signal received from tire detector 33 and the detection value from acceleration sensor 39 of tire detector 33 is identical to a combination of the RSSI value in the signal received from tire detector 35 and the detection value from acceleration sensor 39 of tire detector 35, monitoring unit 45 may discard data representing the RSSI value and the detection value from acceleration sensor 39, and when the combinations of the RSSI value and the detection value from acceleration sensor 39 are different from each other, monitoring unit 45 may specify the tire position.

### Second Embodiment

In the first embodiment described above, an example in which radio wave intensity T1 at which both of tire detectors 33 and 35 are able to sufficiently receive the LF signal even in consideration of attenuation of the LF signal is set as transmission intensity is described. In a second embodiment, an example in which initiator 61 sets as transmission intensity, radio wave intensity T2 at which only tire detector 33 is able to receive the LF signal in consideration of attenuation of the LF signal will be described. In the second embodiment, description of the configuration similar to that in the tire position determination system in the first embodiment will not be repeated.

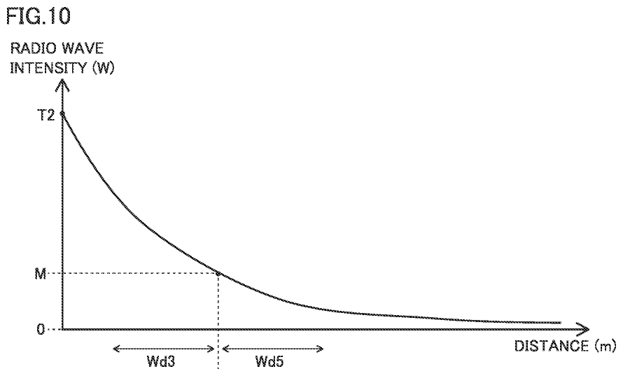

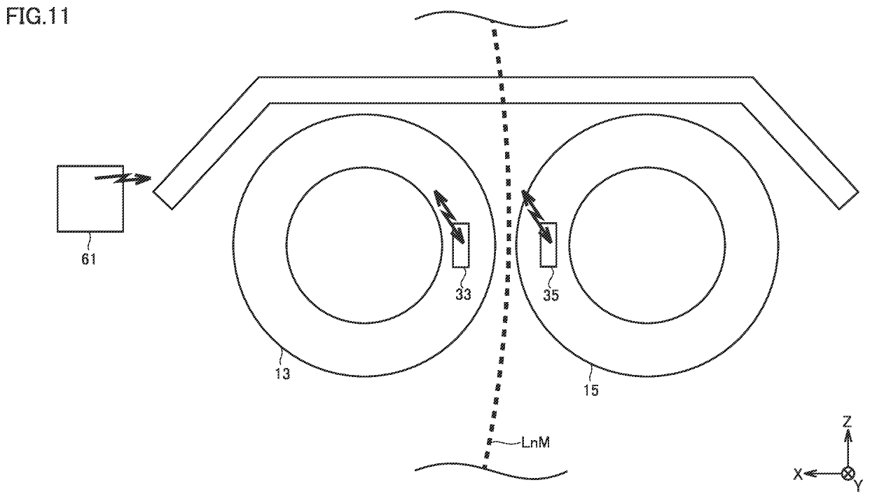

FIG. 10 shows a graph of exemplary attenuation when radio wave intensity T2 is set as transmission intensity. FIG. 10 shows radio wave intensity M. Radio wave intensity M refers to radio wave intensity indicating a boundary beyond which tire detector 30 is unable to receive the LF signal. Specifically, tire detector 30 is configured to be able to receive the LF signal equal to or higher than radio wave intensity M but not to be able to receive the LF signal lower than radio wave intensity M. Reception circuit CR of tire detector 30 is configured to receive the LF signal equal to or higher than radio wave intensity M when antenna L1 senses that LF signal. Radio wave intensity M may correspond to the “third threshold value” in the present disclosure.

As shown in FIG. 10, radio wave intensity T2 which is transmission intensity is set such that radio wave intensity M defined as a reception boundary corresponds to a distance longer than a maximum distance of width Wd3 and shorter than a minimum distance of width Wd5 due to attenuation of the LF signal. Thus, when various factors such as an ambient environment are not taken into account, only tire detector 33 is able to receive the LF signal. As described above, however, the amount of attenuation of radio wave intensity of the LF signal may be changed by the ambient environment. Therefore, depending on arrangement of tire detector 35, tire detector 35 may receive the LF signal at transmission intensity of radio wave intensity M.

FIG. 11 is a diagram illustrating the graph shown in FIG. 10 by referring to initiator 61 and an appearance of tires 13 and 15. A line LnM is a line that shows in a simplified manner, a boundary at which radio wave intensity of the LF signal attains to radio wave intensity M due to attenuation. As shown in FIG. 11, radio wave intensity M is set such that line LnM is arranged between tire 13 and tire 15. When tire detector 35 is arranged in the region close to the initiator such as arrangement 9h and when the amount of attenuation of radio wave intensity of the LF signal decreases due to the ambient environment, tire detector 35 receives the LF signal. In FIG. 11, in response to reception of the LF signal by tire detector 35, tire detector 35 transmits the UHF signal.

When tire detector 35 receives the LF signal due to an error caused in the amount of attenuation, tire detector 35 is arranged in the region close to initiator 61, and in this case, both of tire detectors 33 and 35 may receive the LF signal. When tire detector 35 is in the region distant from initiator 61, it is arranged at a position distant from line LnM. Therefore, even when an error is caused in the amount of attenuation, tire detector 35 is unable to receive the LF signal. In this case, only tire detector 33 receives the LF signal.

In the second embodiment, a method of determining a tire position based on a detection value from acceleration sensor 39 even when tire detector 35 receives the LF signal due to an error as shown in FIG. 11 is described. Radio wave intensity T2 may correspond to the “first radio wave intensity” in the present disclosure.

### As to Tire Position Determination in Second Embodiment

The tire position determination system in the second embodiment has the LF signal transmitted with transmission intensity thereof being set to radio wave intensity T2, and determines the tire position based on arrangement of tire detector 30 estimated from the detection value from acceleration sensor 39.

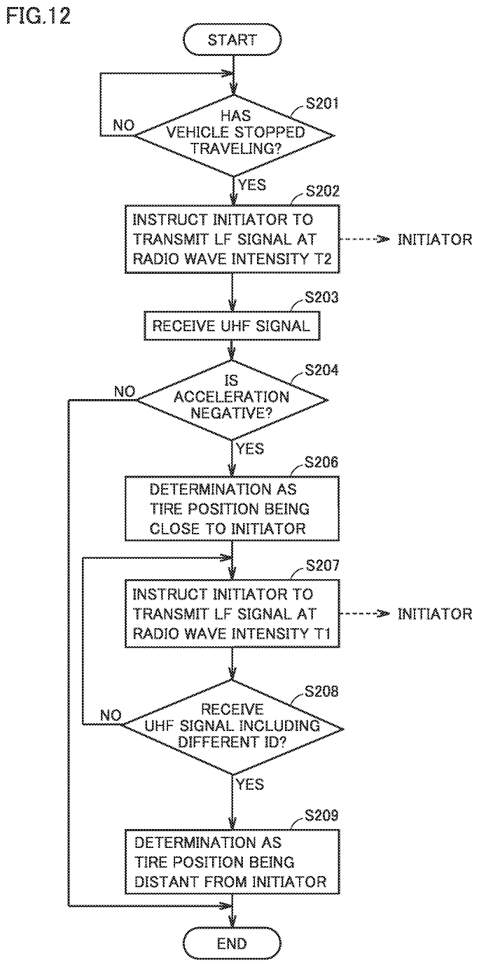

FIG. 12 is a flowchart showing exemplary tire position determination processing in the second embodiment. Monitoring unit 45 determines whether or not vehicle 100 has stopped traveling (step S201). When vehicle 100 has not stopped traveling (NO in step S201), monitoring unit 45 repeats processing in step S201.

When vehicle 100 has stopped traveling (YES in step S201), initiator 61 is instructed to transmit the LF signal at radio wave intensity T2 (step S202). Initiator 61 receives the transmission instruction and transmits the LF signal at radio wave intensity T2. When each of tire detector 33 and tire detector 35 receives the LF signal, it transmits the UHF signal.

Monitoring unit 45 receives the UHF signal (step S203). Monitoring unit 45 determines whether or not the detection value from acceleration sensor 39 included in the received UHF signal is negative (step S204). In other words, monitoring unit 45 determines whether or not tire detector 30 that has transmitted the UHF signal received in step S203 is arranged in the region distant from the initiator in tire 10.

When the detection value from acceleration sensor 39 is not negative (NO in step S204), monitoring unit 45 quits the process. When the detection value is not negative, tire detector 30 that has transmitted the UHF signal in step S203 is arranged in the region close to initiator 61. As described above, when an error is caused in the amount of attenuation and when tire detector 35 is arranged in the region close to initiator 61 in tire 15, tire detector 35 may receive the LF signal and transmit the UHF signal.

Therefore, when monitoring unit 45 receives the UHF signal from tire detector 30 arranged in the region close to initiator 61, it is unable to determine the tire position and quits the process as shown in FIG. 12. In other words, monitoring unit 45 discards data on the UHF signal received in step S203. Monitoring unit 45 may have data on the UHF signal stored in storage 46, instead of discarding the same.

When the detection value from acceleration sensor 39 is negative (YES in step S204), monitoring unit 45 can determine that the UHF signal received in step S203 has been transmitted from tire detector 33 and determines that the tire position is “rear first-row left” (step S206). As shown in FIG. 11, tire detector 30 that can receive the LF signal the transmission intensity of which has attained to radio wave intensity M while it is arranged in the region distant from initiator 61 is only tire detector 33. At this time, monitoring unit 45 has the tire position “rear first-row left” and the ID number included in the UHF signal received in step S203 stored in storage 46 in correspondence with each other.

Then, monitoring unit 45 has initiator 61 transmit the LF signal the transmission intensity of which is set to radio wave intensity T1 (step S207). Monitoring unit 45 determines whether or not it receives the UHF signal with an ID number different from the ID number included in the UHF signal received in step S203 (step S208). When monitoring unit 45 does not receive the UHF signal including the different ID number (NO in step S208), the process returns to step S207 and monitoring unit 45 has initiator 61 transmit the LF signal again.

When monitoring unit 45 receives the UHF signal including the different ID number (YES in step S208), it can determine that the UHF signal with the different ID number has been transmitted from tire detector 35 and determines that the tire position is “rear second-row left” (step S209). Monitoring unit 45 has the tire position “rear second-row left” and the ID number received at a branch in step S208 stored in storage 46 in correspondence with each other.

Thus, the tire position determination system in the second embodiment can determine a plurality of tire positions with the use of single initiator 61 based on the detection value from acceleration sensor 39, also when it has initiator 61 transmit the LF signal the transmission intensity of which is set to radio wave intensity T2.

FIG. 12 illustrates a configuration in which monitoring unit 45 has initiator 61 transmit the LF signal when vehicle 100 stops. In one aspect, monitoring unit 45 may have initiator 61 transmit the LF signal while vehicle 100 is traveling, by removing centrifugal force in accordance with a velocity of vehicle 100 as in FIG. 8.

### Modification of Second Embodiment

Tire 13 is arranged between initiator 61 and tire 15 also in the second embodiment. Initiator 61, however, is not necessarily arranged at the position shown in FIG. 7 and may be arranged at various positions.

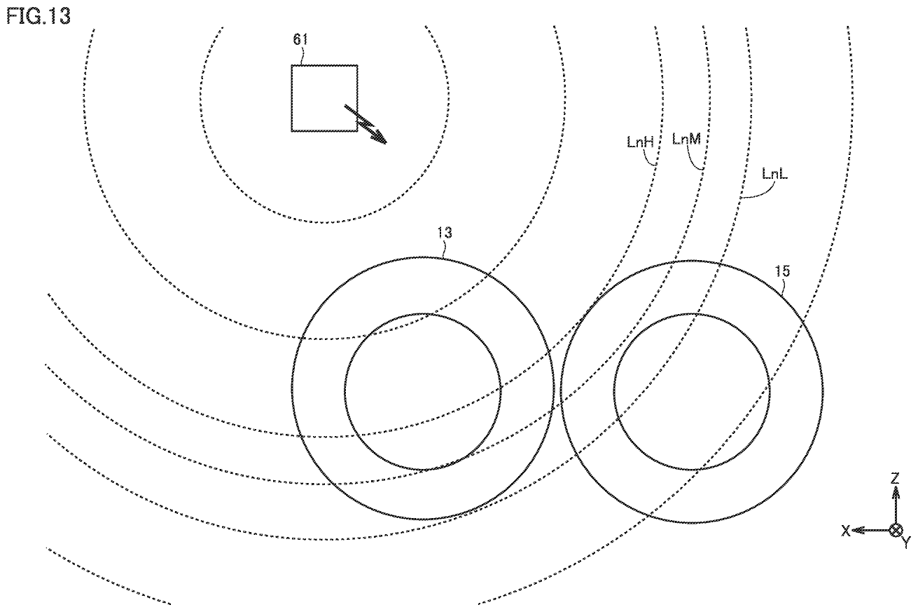

FIG. 13 is a diagram for illustrating arrangement of initiator 61 in a modification of the second embodiment. Initiator 61 in FIG. 13 is arranged at a position similar to the position in FIG. 9. In the modification of the second embodiment, as shown in FIG. 13, line LnM is arranged between line LnL and line LnH. In other words, radio wave intensity M has a value calculated by adding a half value of a value calculated by subtracting radio wave intensity L from radio wave intensity H, to radio wave intensity L.

Thus, even in an example where initiator 61 is arranged as in FIG. 13, monitoring unit 45 can determine the tire position when transmission intensity of the LF signal is set to radio wave intensity T2. In other words, the tire position determination system in the second embodiment can also determine a plurality of tire positions with the use of single initiator 61. The tire position determination system in the second embodiment is thus applicable without limitation being imposed by arrangement of initiator 61.

Though monitoring unit 45 determines the tire position based on whether radio wave intensity is equal to or higher than radio wave intensity H or lower than radio wave intensity L in the first embodiment, it may determine the tire position based on whether radio wave intensity is higher than radio wave intensity H or equal to or lower than radio wave intensity L.

<Modification in Connection with the Number of Tires>

In the first embodiment and the second embodiment, a configuration including one axle in front and two axles in rear in which two tire positions of tires 13 and 15 aligned in the X-axis direction are determined is described. Vehicle 100, however, may be constructed to include three or more axles in rear. Monitoring unit 45 in the first embodiment can determine three more tire positions by newly setting a threshold value in addition to radio wave intensity H and radio wave intensity L.

More specifically, in the tire position determination system, when a further tire is arranged on the side of the negative direction along the X axis of tire 15 shown in FIG. 7, radio wave intensity corresponding to a boundary line that passes through a central point of the tire arranged on the side of the negative direction along the X axis is set as a new threshold value. When the UHF signal includes the RSSI value at radio wave intensity lower than radio wave intensity set as the new threshold value, monitoring unit 45 can determine that the UHF signal has been transmitted from the tire arranged on the side of the negative direction along the X axis of tire 15.

When monitoring unit 45 receives the UHF signal including the RSSI value at radio wave intensity equal to or higher than radio wave intensity set as the new threshold value, it can determine from tire detector 30 of which of tire 15 and the tire arranged on the side of the negative direction along the X axis of tire 15 the UHF signal has been transmitted, based on the detection value from acceleration sensor 39. Thus, even in an example where the number of tires is increased to three or more, by increase of the threshold value, monitoring unit 45 can determine the tire position.

It should be understood that the embodiments disclosed herein are illustrative and non-restrictive in every respect. The scope of the present disclosure is defined by the terms of the claims rather than the description above and is intended to include any modifications within the scope and meaning equivalent to the terms of the claims.

The illustrative embodiments and the modifications thereof described above are specific examples of aspects below.

(1) A tire position determination system according to one aspect of the present disclosure is a tire position determination system provided in a vehicle including a first tire and a second tire different from the first tire. The tire position determination system includes an initiator that transmits a command signal, a first detector attached to the first tire, the first detector transmitting a detection signal when the first detector receives the command signal, a second detector attached to the second tire, the second detector transmitting a detection signal when the second detector receives the command signal, and a monitoring unit configured to receive the detection signal. A first distance between the first tire and the initiator is equal to or shorter than a second distance between the second tire and the initiator. Each of the first detector and the second detector includes an acceleration sensor that detects an acceleration in a direction orthogonal to a revolution axis direction. The detection signal includes a detection value from the acceleration sensor. When the monitoring unit receives the detection signal from the first detector or the second detector, the monitoring unit performs determination processing for determining whether a detector that has transmitted the detection signal is the first detector or the second detector based on positional relation between the detector that has transmitted the detection signal and the initiator estimated from the detection value from the acceleration sensor included in the received detection signal.

According to the aspect above, when the monitoring unit is unable to determine the tire position only based on reception intensity, it can determine the tire position based on whether or not the tire detector is arranged in the region close to the initiator. The tire position determination system can thus determine the tire position of each of the plurality of tires with the use of a single initiator.

(2) In one aspect, the detection signal further includes reception intensity of the command signal from the initiator. The monitoring unit has the initiator transmit the command signal. When the reception intensity included in the received detection signal is equal to or higher than a first threshold value, the monitoring unit determines that the detector that has transmitted the detection signal is the first detector. When the reception intensity included in the received detection signal is lower than a second threshold value, the monitoring unit determines that the detector that has transmitted the detection signal is the second detector. When the reception intensity included in the received detection signal is lower than the first threshold value and equal to or higher than the second threshold value, the monitoring unit performs the determination processing.

According to the aspect above, even when the distance between tire detector 33 and tire detector 35 is short in tire 13 and tire 15, the tire position determination system can determine the tire position by estimating arrangement of tire detector 33 and tire detector 35.

(3) In one aspect, the first threshold value and the second threshold value are determined in accordance with arrangement of the initiator, the first tire, and the second tire.

According to the aspect above, the tire position determination system can determine an appropriate threshold value based on arrangement of the initiator, the first tire, and the second tire.

(4) In one aspect, the first threshold value is set such that the second tire is not included but at least a part of the first tire is included in a range where attenuated intensity of the command signal is equal to or higher than the first threshold value, and the second threshold value is set such that the first tire is not included but at least a part of the second tire is included in a range where attenuated intensity of the command signal is lower than the second threshold value.

According to the aspect above, radio wave intensities L and H can be determined based on the distances between initiator 61 and tires 13 and 15 and attenuation of the LF signal.

(5) In one aspect, the monitoring unit has the initiator transmit the command signal at first radio wave intensity. When the monitoring unit estimates based on the detection value from the acceleration sensor included in the received detection signal that the detector that has transmitted the detection signal is not arranged in a region close to the initiator in the first tire or the second tire, the monitoring unit determines that the detector that has transmitted the detection signal is the first detector. When the monitoring unit estimates based on the detection value from the acceleration sensor included in the received detection signal that the detector that has transmitted the detection signal is arranged in the region close to the initiator in the first tire or the second tire, the monitoring unit discards the detection signal. The first radio wave intensity is set such that the second tire is not included but the first tire is included in a range where attenuated intensity of the command signal is equal to or higher than a third threshold value, and the first detector or the second detector is configured to be unable to receive the command signal at reception intensity lower than the third threshold value and to be able to receive the command signal at reception intensity equal to or higher than the third threshold value.

According to the aspect above, the tire position determination system can determine the tire position by causing transmission of the LF signal transmission intensity of which is set to radio wave intensity T2.

(6) In one aspect, the first tire is arranged between the initiator and the second tire.

According to the aspect above, the region close to initiator 61 and the region distant from initiator 61 in tires 13 and 15 can suitably be determined.

Though embodiments of the present invention have been described, it should be understood that the embodiments disclosed herein are illustrative and non-restrictive in every respect. The scope of the present invention is defined by the terms of the claims and is intended to include any modifications within the scope and meaning equivalent to the terms of the claims.

What is claimed is:

1. A tire position determination system provided in a vehicle including a first tire and a second tire different from the first tire, the tire position determination system comprising:
an initiator that transmits a command signal;
a first detector attached to the first tire, the first detector transmitting a detection signal when the first detector receives the command signal;
a second detector attached to the second tire, the second detector transmitting a detection signal when the second detector receives the command signal; and
a monitoring unit configured to receive the detection signal, wherein
a first distance between the first tire and the initiator is equal to or shorter than a second distance between the second tire and the initiator,
each of the first detector and the second detector includes an acceleration sensor that detects an acceleration in a direction orthogonal to a revolution axis direction,
the detection signal includes a detection value from the acceleration sensor, and
when the monitoring unit receives the detection signal from the first detector or the second detector, the monitoring unit performs determination processing for determining whether a detector that has transmitted the detection signal is the first detector or the second detector based on positional relation between the detector that has transmitted the detection signal and the initiator estimated from the detection value from the acceleration sensor included in the received detection signal.

2. The tire position determination system according to claim 1, wherein
the monitoring unit performs the determination processing for determining whether the detector that has transmitted the detection signal is the first detector or the second detector based on transmission intensity in transmission of the command signal by the initiator or reception intensity in reception of the command signal from the initiator by the detector.

3. The tire position determination system according to claim 1, wherein
the detection signal further includes reception intensity of the command signal from the initiator,
the monitoring unit has the initiator transmit the command signal,
when the reception intensity included in the received detection signal is equal to or higher than a first threshold value, the monitoring unit determines that the detector that has transmitted the detection signal is the first detector,
when the reception intensity included in the received detection signal is lower than a second threshold value, the monitoring unit determines that the detector that has transmitted the detection signal is the second detector, and
the monitoring unit performs the determination processing when the reception intensity included in the received detection signal is lower than the first threshold value and equal to or higher than the second threshold value.

4. The tire position determination system according to claim 3, wherein
the first threshold value and the second threshold value are determined in accordance with arrangement of the initiator, the first tire, and the second tire.

5. The tire position determination system according to claim 3, wherein
the first threshold value is set such that the second tire is not included but at least a part of the first tire is included in a range where attenuated intensity of the command signal is equal to or higher than the first threshold value, and
the second threshold value is set such that the first tire is not included but at least a part of the second tire is included in a range where attenuated intensity of the command signal is lower than the second threshold value.

6. The tire position determination system according to claim 1, wherein
the monitoring unit has the initiator transmit the command signal at first radio wave intensity,
when the monitoring unit estimates based on the detection value from the acceleration sensor included in the received detection signal that the detector that has transmitted the detection signal is not arranged in a region close to the initiator in the first tire or the second tire, the monitoring unit determines that the detector that has transmitted the detection signal is the first detector, and
when the monitoring unit estimates based on the detection value from the acceleration sensor included in the received detection signal that the detector that has transmitted the detection signal is arranged in the region close to the initiator in the first tire or the second tire, the monitoring unit discards the detection signal,
the first radio wave intensity is set such that the second tire is not included but the first tire is included in a range where attenuated intensity of the command signal is equal to or higher than a third threshold value, and
the first detector or the second detector is configured to be unable to receive the command signal at reception intensity lower than the third threshold value and to be able to receive the command signal at reception intensity equal to or higher than the third threshold value.

7. The tire position determination system according to claim 1, wherein
the first tire is arranged between the initiator and the second tire.
